(19) United States
(12) Patent Application Publication
(10) Pub. No.: US 2015/0145732 A1
(43) Pub. Date: May 28, 2015

(54) DISPLAY APPARATUS PROVIDED WITH ANTENNAS

(71) Applicant: Kabushiki Kaisha Toshiba, Tokyo (JP)

(72) Inventors: Takashi Minemura, Ome-shi (JP); Takayuki Saito, Isesaki-shi (JP)

(21) Appl. No.: 14/461,020

(22) Filed: Aug. 15, 2014

Related U.S. Application Data
(60) Provisional application No. 61/909,219, filed on Nov. 26, 2013.

(51) Int. Cl. H01Q 1/24

(52) U.S. Cl. CPC H01Q 1/24
USPC 343/702

(57) ABSTRACT

In a display apparatus according to one embodiment, a substantially oblong display panel has a flat placement area adjacent to one corner on a back surface, and a frame retaining the display panel is composed of four metal bezel members attached to four sides, and two nonconductive bezel members attached to two sides in order to extend two metal bezel members and constituting a substantially L-shape. A triangular area is defined by the two nonconductive bezel members. A pair of antennas is provided in the flat placement area so as to be substantially symmetrical with respect to a bisector bisecting a corner. An antenna module provided on the placement area drives the antennas in order to constitute a group of antennas communicating at a same time in a same system.

### CROSS-REFERENCE TO RELATED APPLICATIONS

This application claims the benefit of U.S. Provisional Application No. 61/909,219, filed Nov. 26, 2013, the entire contents of which are incorporated herein by reference.

### FIELD

Embodiments described herein relate generally to a display apparatus provided with antennas.

### BACKGROUND

Display apparatuses employ a structure in which a display panel as a display portion, for example, a liquid crystal panel, is retained by an casing (frame) surrounding the periphery of the panel. The width of the front surface of the bezel (casing) composing the frame (the length of the casing exposed on the display surface side) tends to be narrowed or reduced so that the display surface of the display panel can appear larger and the display apparatus itself can appear light in terms of design although the display apparatus comprises a large display surface. Thus, there is a trend toward narrowed frames. Moreover, display apparatuses themselves are also becoming thinner as the thickness is becoming smaller. In this manner, the length of the thickness (the width of the thickness) of the bezel of the display apparatuses also becomes short. In order to provide sufficient strength for the display apparatuses, the material of the frame is shifting from a resin bezel to a metal bezel.

In a display apparatus provided with antennas, because frames are becoming narrower and thinner, and hence smaller, antennas or wireless modules for the antennas cannot be housed in a frame and tend to be mounted on the back surface of the display panel surrounded by the frame instead of being mounted within the frame.

Moreover, the use of display apparatuses is not limited to situations where the oblong (rectangular) display surface is landscape-oriented, such as for viewing TV. As with a tablet display apparatus, the orientation of the oblong (rectangular) display surface is not constrained, and the display surface is portrait- or landscape-oriented for display. Not only is there no constraint on the orientation of the display surface for a tablet portable display apparatus, but also for a fixed display apparatus. A fixed display apparatus is used for display as a multidisplay or an advertising medium for digital signage hung on a wall, etc. Thus, the fixed display apparatus is also portrait- oriented or landscape-oriented.

As described above, the frames of display apparatuses are becoming smaller as they are made narrower and thinner. Further, display apparatuses are placed or set in various ways. Because of these factors, a problem arises: as the emission pattern (orientation pattern) of wireless waves is restricted by a metal bezel, the performance of antennas is reduced. Moreover, because of the restriction of placement of antenna devices themselves, the antenna devices can be assumed to interfere with surrounding components in terms of the structure. Since display apparatuses are used in portrait and landscape orientation, the wireless performance of antenna devices may be unsteady, and unstable transmission may result. In addition, it has been noted that the diversity in the placement of display apparatuses causes the restriction of emission pattern of wireless waves, thereby interrupting transmission and reception in antenna devices.

In the case where a frame is formed by bending a metal bezel, it is necessary to prevent wrinkles forming on the metal surface of the frame, etc. Thus, the process of manufacturing the frame is complicated. Furthermore, as the screens of display devices become large, the workability of mounting a display panel in a frame is reduced. When the bezel of the display apparatus is exchanged, the whole frame must be exchanged, etc.

A frame can be composed by combining bar-like bezel members. However, such a frame has a problem with its appearance in that the combined portions exhibit black lines.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a back surface view schematically showing the back surface of a display apparatus provided with an antenna device according to an embodiment.

FIG. 2 is a partial perspective illustration showing a structure of the display apparatus provided with the antenna device according to the embodiment, in which the area shown by dashed lines in FIG. 1 is partially enlarged.

FIG. 3 is a partial perspective illustration showing a structure of a display apparatus provided with an antenna device according to another embodiment, in which the area shown by dashed lines in FIG. 1 is partially enlarged.

FIG. 4A is a partial perspective illustration showing a structure of a display apparatus provided with an antenna device comprising a frame consisting of metal bezel members according to a comparison example.

FIG. 4B is a graph showing an emission pattern (absolute value) of a transmission wave from the antenna device within the X-Y plane of the display apparatus shown in FIG. 4A.

FIG. 4C is a graph showing an impedance frequency property and a reflection loss frequency property in the antenna device of the display apparatus shown in FIG. 4A.

FIG. 5A is a partial perspective illustration showing a structure of a display apparatus provided with an antenna device comprising a frame consisting of resin bezel members according to a comparison example.

FIG. 5B is a graph showing an emission pattern of a transmission wave from the antenna device within the X-Y plane of the display apparatus shown in FIG. 5A.

FIG. 5C is a graph showing an impedance frequency property and a reflection loss frequency property in the antenna device of the display apparatus shown in FIG. 5A.

FIG. 6A is a partial perspective illustration showing a structure of a display apparatus provided with an antenna device comprising a frame composed by combination of metal and resin bezel members according to an embodiment.

FIG. 6B is a graph showing an emission pattern of a transmission wave from the antenna device within the X-Y plane of the display apparatus shown in FIG. 6A.

FIG. 6C is a graph showing an impedance frequency property and a reflection loss frequency property in the antenna device of the display apparatus shown in FIG. 6A.

FIG. 7A is a partial perspective illustration showing a structure of a display apparatus provided with an antenna device comprising a frame composed by combination of metal and resin bezel members, the antenna device further comprising an antenna provided on the frame, according to another embodiment.

FIG. 7B is a graph showing a three-dimensional emission pattern of a transmission wave from the antenna device in the display apparatus shown in FIG. 7A when the antenna device is laterally placed.

FIG. 8A is a graph showing an emission pattern of the transmission wave from the antenna device within the X-Y plane of the display apparatus shown in FIG. 7A.

FIG. 8B is a graph showing an emission pattern of the transmission wave from the antenna device within the X-Z plane of the display apparatus shown in FIG. 7A.

FIG. 8C is a graph showing an emission pattern of the transmission wave from the antenna device within the Y-Z plane of the display apparatus shown in FIG. 7A.

FIG. 9 is a graph showing a three-dimensional emission pattern of the transmission wave from the antenna device in the display apparatus shown in FIG. 7A when the antenna device is longitudinally placed.

FIG. 10A is a graph showing an emission pattern of the transmission wave from the antenna device within the X-Y plane of the display apparatus shown in FIG. 9.

FIG. 10B is a graph showing an emission pattern of the transmission wave from the antenna device within the X-Z plane of the display apparatus shown in FIG. 9.

FIG. 10C is a graph showing an emission pattern of the transmission wave from the antenna device within the Y-Z plane of the display apparatus shown in FIG. 9.

FIG. 11A is a pattern diagram showing a display apparatus having placement of an antenna module and antennas according to a modified embodiment.

FIG. 11B is a pattern diagram showing a display apparatus having placement of an antenna module and antennas according to another modified embodiment.

FIG. 11C is a pattern diagram showing a display apparatus having placement of an antenna module and antennas according to another modified embodiment.

### DETAILED DESCRIPTION

Various embodiments will be described hereinafter with reference to the accompanying drawings.

In general, according to one embodiment, a display apparatus comprises a display panel and a frame retaining the display panel. The display panel has a substantially oblong outer shape having four corners and four sides. The display panel comprises a display surface on the front surface, and a flat placement area adjacent to at least one of the four corners on the back surface. The frame is composed of four metal bezel members attached to the four sides, and two nonconductive bezel members. These two nonconductive bezel members are combined with two of the four metal bezel members, are attached to two sides to which the two metal bezel members are attached so as to extend the two metal bezel members, and constitute a substantially L-shape. A triangular area or a rectangular area is defined by the two nonconductive bezel members as two linear sides. A pair of antennas is provided on the nonconductive bezel members or in the flat placement area, and is arranged so as to be substantially symmetrical with respect to a diagonal line connecting said one corner and its opposed corner, or a bisector bisecting said one corner. An antenna module has a portion provided so as to overlap the triangular area or the rectangular area, and is placed and fixed in the flat placement area of the display panel. The antenna module is connected to the antennas, comprises a power supplying portion which supplies electric power to the antennas, and drives the antennas so as to constitute a group of antennas communicating at the same time in the same system.

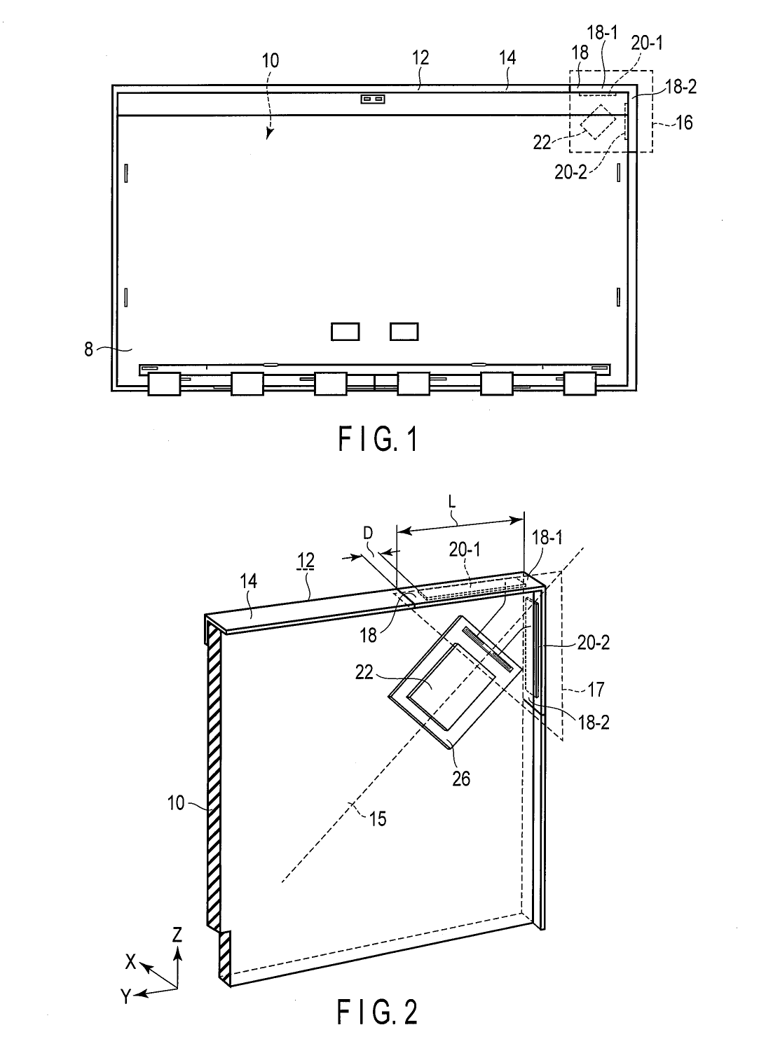

FIG. 1 illustrates an example of a back surface structure of the display apparatus. This display apparatus has a structure in which an oblong (rectangular) display panel 10 whose outer shape has four sides, for example, a liquid crystal display panel or an organic EL display panel, fits in a rectangular frame 12. More specifically, the outer periphery of the display panel 10 is covered by the frame 12 so as to expose the display surface on the front surface side of the display panel 10. The back surface of the display panel 10 is covered by a back panel (back bezel member) 8 extending from the frame 12 to the back surface side.

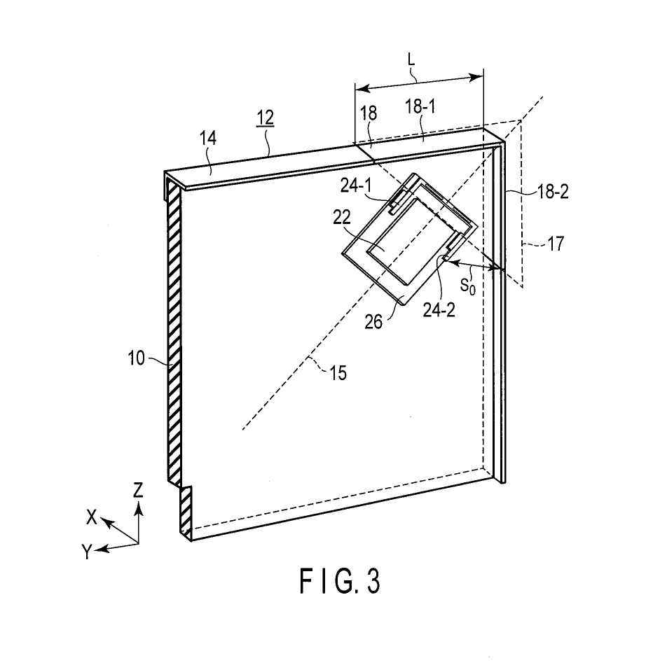

In the display apparatus shown in FIG. 1, the frame 12 has four vertexes, and most parts of the frame 12 including three vertexes are made by a metal bezel member 14. A bezel member 18 of a corner which includes one vertex and is provided within a substantially square or oblong area 16 as shown by dashed lines is made of a nonconductive material such as resin. Hereinafter, the nonconductive material is merely explained as resin. In the display apparatus shown in FIG. 1, preferably, in addition to the bezel member 18 of a corner, a portion which is provided in the back panel (back bezel member) 8 and extends from the bezel member 18 over the aforementioned area is made of a nonconductive material (resin). This portion of the back panel (back bezel member) 8 is equivalent to an area facing the substantially square or oblong area 16, or an area facing a triangular area 17 sectionalizing the area 16 as shown in FIG. 2. The bezel member 18 consists of two resin bezel members 18-1 and 18-2 which are combined in an L-shape. As linear sides, the resin bezel members 18-1 and 18-2 geometrically define the substantially square or oblong area 16, and the triangular area 17 shown in FIG. 2. The triangular area 17 is determined in such a way that its three vertexes are equivalent to the connection point of the resin bezel members 18-1 and 18-2 (a corner of the resin bezel member 18), the border of the resin bezel member 18-1 and the metal bezel member 14, and the border of the resin bezel member 18-2 and the metal bezel member 14. An antenna module 22 which receives a reception wave from antennas 20-1 and 20-2 and modulates the reception wave, for example, a wireless LAN module, is provided within the area 16 shown by dashed lines.

The frame 12 may be composed by combining the metal bar type of bezel member 14 and the resin bar type of bezel members 18-1 and 18-2. The fitting structure of bar type of bezel members can conceal the connection portions of the frame 12. Thus, the appearance of the frame can be improved.

At least two antennas 20-1 and 20-2 connected to the antenna module 22 (wireless LAN module) constitute a group of antennas composed of antenna devices communicating at the same time in the same system.

FIG. 2 is a perspective illustration in which the area 16 shown in FIG. 1 is partially enlarged. Similarly to FIG. 1, the perspective illustration of FIG. 2 also illustrates the back surface side of the display apparatus. However, in order to clearly show the placement of the antenna module 22, the inside structure is illustrated with the back panel (back bezel member) 8 being transparent. As shown in FIG. 2, the antenna module 22 is placed and fixed on the flat surface (in the flat placement area) of the main plate provided on the back surface of the display panel 10 through an antenna plate 26. In the case where a main ground plate is provided on the back surface of the display panel 10, the antenna module 22 may be placed and fixed on the main ground plate through the antenna plate 26. The frame 12 has four vertexes. The antenna module 22 is provided so as to be symmetrically divided with respect to, as a base line, a diagonal line 15 connecting two vertexes opposed to each other among the four vertexes, or a bisector bisecting a corner including one of the four vertexes. Thus, the base line is the diagonal line 15, or the bisector bisecting an orthogonal corner of the bezel member. The line symmetry may not be strict symmetry. Two or more than two antennas 20-1 and 20-2 should only be provided so as to extend in a direction orthogonal to or intersecting with each other on the both sides of the base line sectionalizing the triangular area 17.

In the display apparatus shown in FIG. 2, the frame 12 is composed by combining the metal bezel member 14 and the resin bezel member 18. Within the area 16, the resin bezel member 18 is formed into an L-shape comprising the longitudinal bezel member 18-1 and the lateral bezel member 18-2 so as to form two sides of a triangle whose base line is a diagonal line, preferably, two sides of an isosceles triangle. The first and second antennas 20-1 and 20-2 are mounted on the longitudinal bezel member 18-1 and the lateral bezel member 18-2 respectively. The antenna module 22 is provided in such a way that at least a part of the antenna module 22 overlaps the triangular area. The first and second antennas 20-1 and 20-2 provided in the resin bezel members 18-1 and 18-2 which are formed into an L-shape are each connected to the power supplying point placed in the antenna module 22. The first and second antennas 20-1 and 20-2 are fixed to the linear portion of each of the resin bezel members 18-1 and 18-2 which are formed into an L-shape in such a way that the first and second antennas 20-1 and 20-2 are substantially symmetrical with respect to, as the base line, the diagonal line 15 or the bisector bisecting one corner. The line symmetry of the antennas may not be strict symmetry. Two or more than two antennas 20-1 and 20-2 has only to be provided so as to extend in the direction orthogonal to or intersecting with each other on the both sides of the base line sectionalizing the triangular area 17. Preferably, the longitudinal bezel member 18-1 and the lateral bezel member 18-2 which are made of resin have a length L of λ·¼ to λ. The first and second antennas 20-1 and 20-2 are preferably provided in such a way that a distance D from the outermost end of the first and second antennas 20-1 and 20-2 to the end of the metal bezel member 14 is λ· 1/10 or more than λ· 1/10. Here, λ is the wavelength of transmission and reception waves. The first and second antennas 20-1 and 20-2 preferably resonate at a multifrequency. The first and second antennas 20-1 and 20-2 are preferably provided on the inner surface side of the L-shaped resin bezel member 18 in terms of appearance. For example, in the antennas operated at three frequency bands of 2.4, 5 and 60 GHz, if the communication rate at 2.4 GHz is low, the frequency band of 5 GHz can be used. If a high communication rate in an extremely-close distance is requested, the frequency band of 60 GHz can be used. Thus, the antennas have an advantage of switching frequency bands for use.

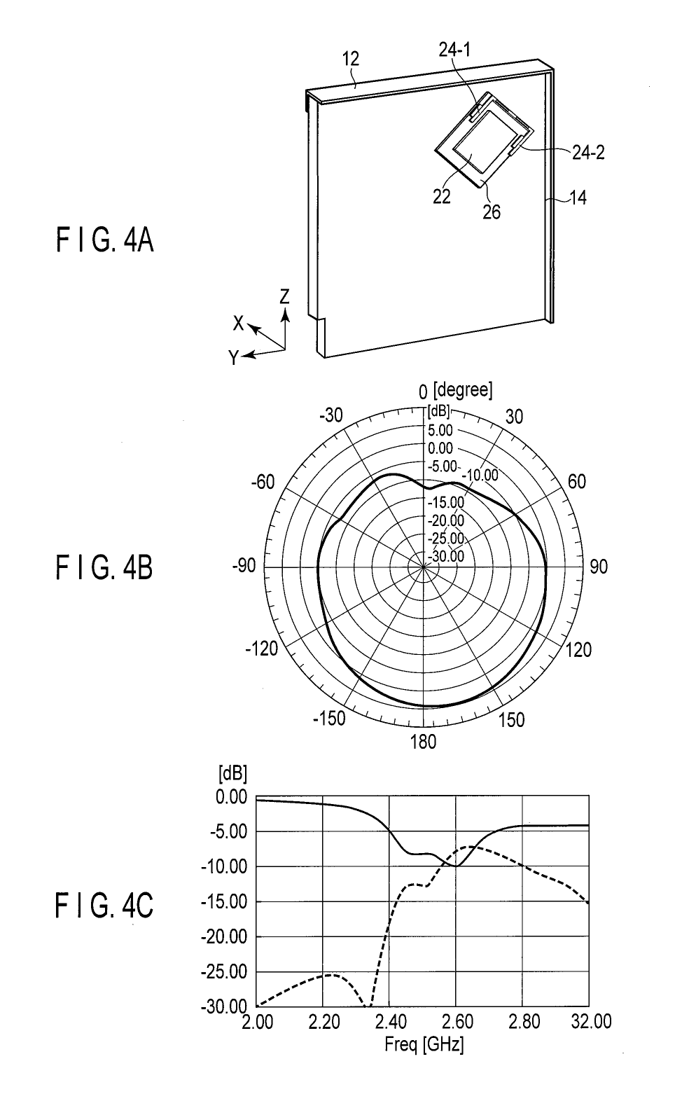

FIG. 3 shows another embodiment of the display apparatus. In this embodiment, as shown in FIG. 3, instead of the first and second antennas 20-1 and 20-2, third and fourth antennas 24-1 and 24-2 are provided in the antenna module 22 and used as transmission and reception antennas. As a modified example of the embodiment, in addition to the first and second antennas 20-1 and 20-2 in FIG. 2, the third and fourth antennas 24-1 and 24-2 in FIG. 3 may be further provided. The structure in which the third and fourth antennas 24-1 and 24-2 are provided in addition to the first and second antennas 20-1 and 20-2 can be applied to a multi-input multi-output (MIMO) system.

A ground (GND) line or a ground (GND) layer is provided on the substrate of the display panel 10. However, in the display apparatus using the antennas 24-1 and 24-2 provided in the antenna module 22 as transmission and reception antennas, in order to obtain good sensitivity for the antenna 20, preferably, an area which belongs to the panel 10, faces the substrate of the antenna module 22 and is equivalent to the area 16 or the area 17 is made of a non-metal (for example, resin). The ground (GND) line, the ground plate or the ground (GND) layer does not preferably extend to the above area of the panel 10. In terms of an idea that a structure in which fewer conductive components are provided within the area 16 or the area 17 is adopted, the display panel 10 which is an organic light-emitting diode (OLED) organic EL panel permeable to electric waves is more preferably employed as compared with a liquid crystal panel. By using an organic light-emitting diode (OLED) organic EL panel permeable to electric waves as the display panel 10, the areas 16 and 17 which do not comprise a conductor can be prepared, and the emission of stronger electric waves to the front side of the display panel 10 can be realized. Thus, the communication in the front direction becomes easy. This is an advantage of the structure.

The pair of antennas 24-1 and 24-2 is provided on the substrate 26 of the antenna module 22 so as to be substantially symmetrical with respect to, as the basis, the diagonal line 15 or the bisector bisecting said one corner. In order to place the pair of antennas 24-1 and 24-2 so as to be more close to the vertex of the L-shaped resin bezel member 18, the basal portion which is the power supplying point of the pair of antennas 24 is provided on the vertex side. The pair of antennas 24 is extended from the power supplying portion along the base line. The free ends are directed to the middle of the panel. The free ends of the pair of antennas 24-1 and 24-2 are preferably away from the metal bezel member 14 by at least a predetermined distance S0 (=λ· 1/10). By separating the antenna 24 by more than the predetermined distance S0 (=λ· 1/10), it is possible to prevent the transmission wave emitted from the antenna 24 and the reception wave received by the antennas 24-1 and 24-2 from being affected, for example, being reduced, by the metal bezel member 14. Similarly to the antennas 20-1 and 20-2, the antennas 24-1 and 24-2 preferably resonate at a multifrequency.

In the above-described embodiment, the bezel member is made of resin in the area 16 including one vertex of the frame 12. The antenna device including the antenna 20 and the antenna module 22 is provided in the area 16. The bezel member 18 may be made of resin in the substantially square or oblong area 16 including another vertex of the frame 12. In such a structure, the combination of the metal bezel members 14 bent at two vertexes and the linear metal bezel members 14 may be provided in the substantially square or oblong areas 16 lacking corners. The bent resin bezel members 18 may be connected to the lacking two corners, and be composed in the substantially square or oblong areas 16.

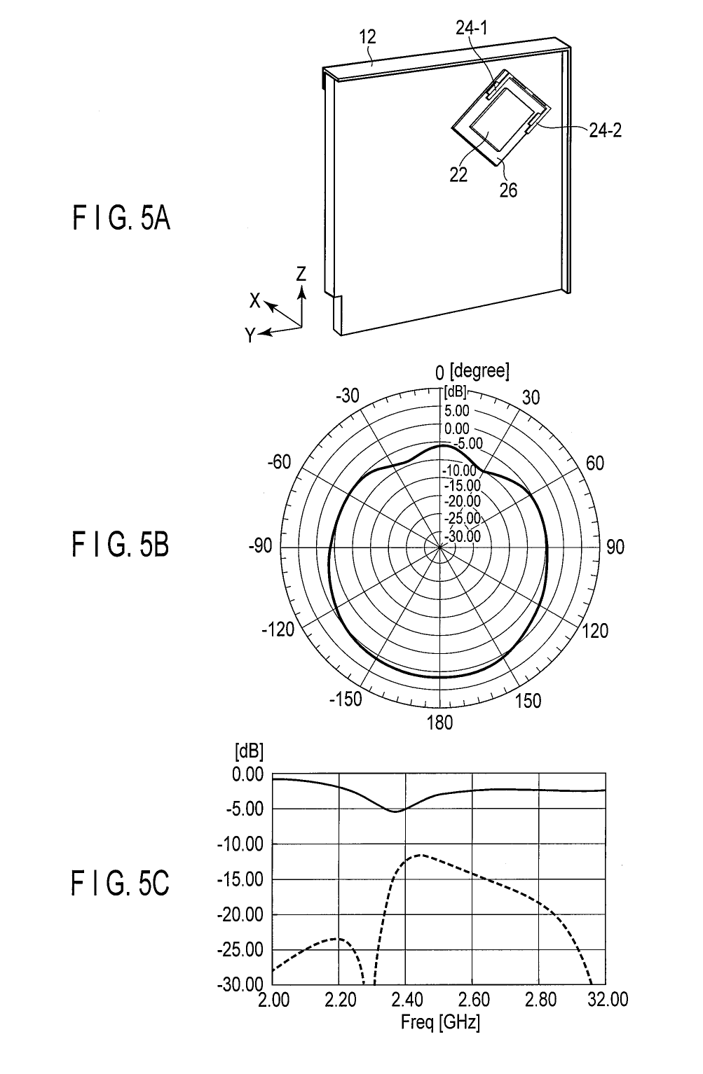

FIG. 4A, FIG. 4B and FIG. 4C show a structure of a display apparatus comprising an antenna device comprising the antenna 24 and the antenna module 22 on the substrate 26 according to a first comparison example, a graph showing an emittion pattern (absolute value) on the X-Y plane of the display apparatus comprising the structure, and an impedance frequency property and an antenna reflection loss frequency property in the antenna device in the structure.

The first comparison example is a display device in which all of the bezel member 14 consisting the frame 12 is made of metal. In the first comparison example, as shown in FIG. 4B, the electric wave strength on the front side (zero degrees) of the display apparatus is reduced to −10 dB. Further, as shown in FIG. 4C, the impedance frequency property and the antenna reflection loss frequency property are disturbed, and double resonance is generated.

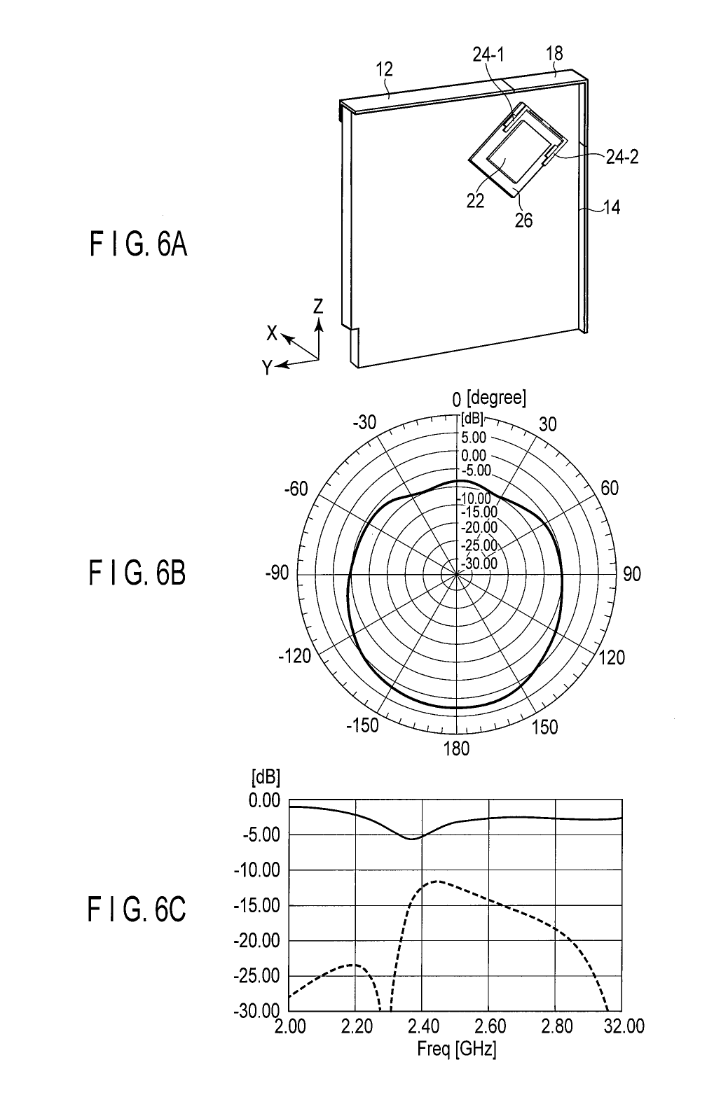

FIG. 5A, FIG. 5B and FIG. 50 show a structure of a display apparatus comprising an antenna device according to a second comparison example comprising the antenna 24 and the antenna module 22 on the substrate 26, a graph showing an emission pattern (absolute value) on the X-Y plane of the display apparatus comprising the structure, and an impedance frequency property and an antenna reflection loss frequency property in the antenna device in the structure.

The second comparison example is a display apparatus in which all of the frame 12 is composed of the resin bezel member 18. In the second comparison example, as shown in FIG. 5B, the electric wave strength on the front side (zero degrees) of the display apparatus remains at −5 dB, and is larger than the electric wave strength shown in FIG. 4B. Further, as shown in FIG. 5C, the impedance frequency property and the antenna reflection loss frequency property are not largely disturbed compared with the properties shown in FIG. 4C. Single resonance is generated as desired.

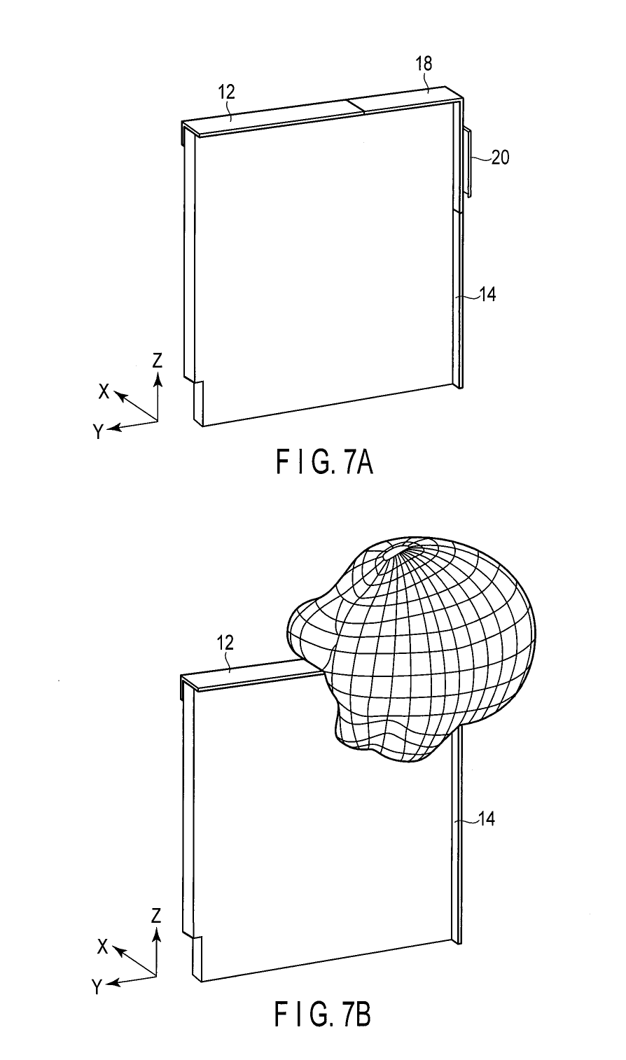

FIG. 6A, FIG. 6B and FIG. 6C show a structure of the display apparatus comprising the antenna device according to said another embodiment comprising the antenna 24 and the antenna module 22 on the substrate 26, a graph showing an emission pattern (absolute value) on the X-Y plane of the display apparatus comprising the structure, and an impedance frequency property and an antenna reflection loss frequency property in the antenna device in the structure.

In the display apparatus of this embodiment, the frame 12 is composed of the metal bezel member 14 and the resin bezel member 18. In this embodiment, as shown in FIG. 6B, the electric wave strength on the front side (zero degrees) of the display apparatus remains at −5 dB, and is larger than the electric wave strength shown in FIG. 4B, similarly to FIG. 5B. Further, as shown in FIG. 6C, similarly to FIG. 5C, the impedance frequency property and the antenna reflection loss frequency property are not largely disturbed compared with the properties shown in FIG. 4C, and single resonance is generated as desired.

Note that the properties in FIG. 4B, FIG. 5B and FIG. 6B and FIG. 4C, FIG. 5C and FIG. 6C are obtained by a simulation at a state where the back panel (back bezel member) 8 is removed from the display apparatus.

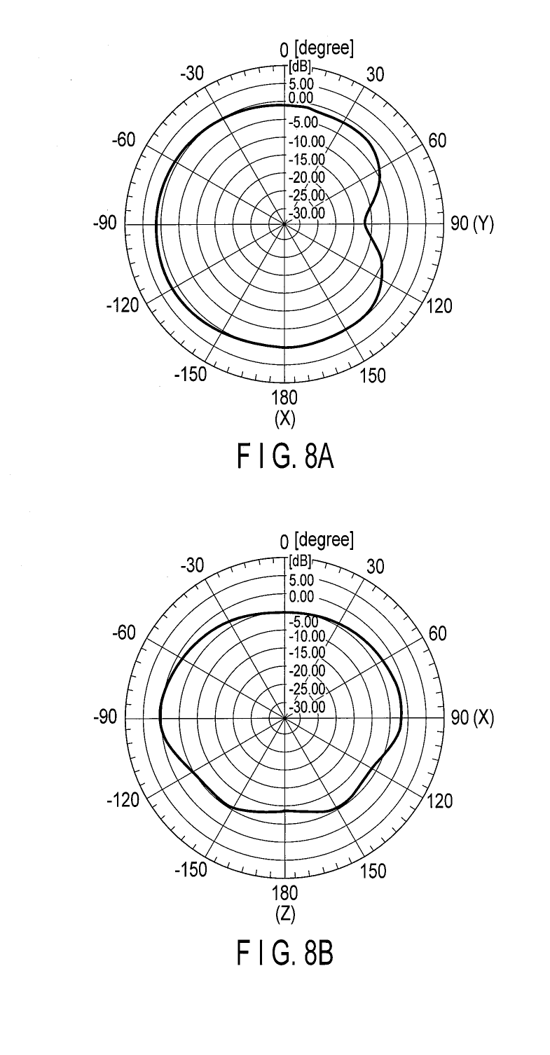

FIG. 7A is a partial perspective illustration showing a structure of a display device comprising a frame prepared by combining a metal bezel member and a resin bezel member, and an antenna device in which one antenna 20 is provided on the resin bezel member 18-2 of the direction along the short side of the display apparatus on the casing.

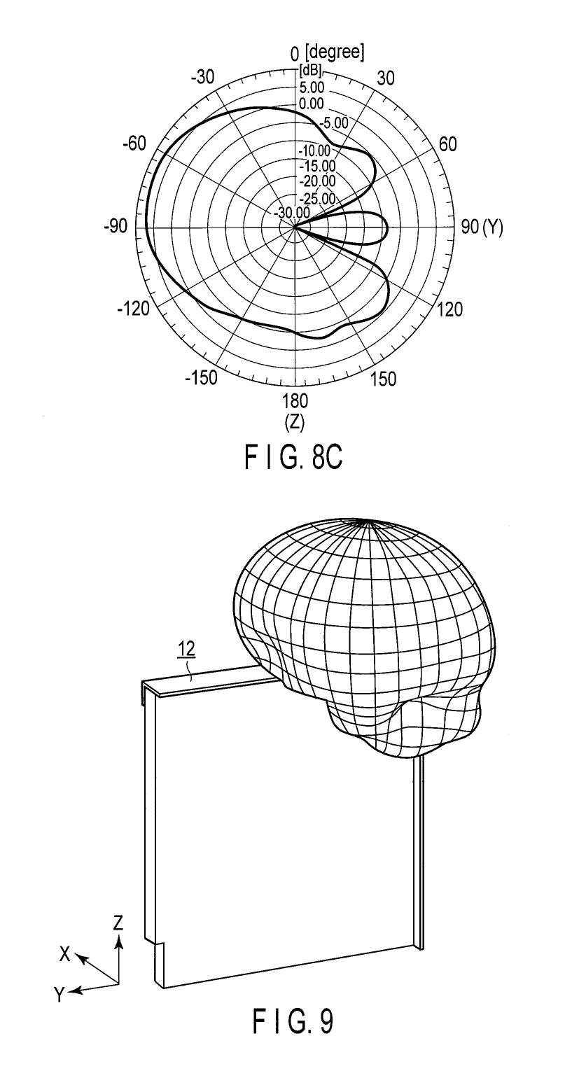

FIG. 7B shows a three-dimensional emission pattern when the display apparatus shown in FIG. 7A is laterally placed, and the antenna 20 is placed in the longitudinal direction as shown in FIG. 7B. FIG. 8A, FIG. 8B and FIG. 8C show graphs of emission patterns of the transmission wave from the antenna device within the X-Y plane, X-Z plane and Y-Z plane of the three-dimensional emission pattern shown in FIG. 7B.

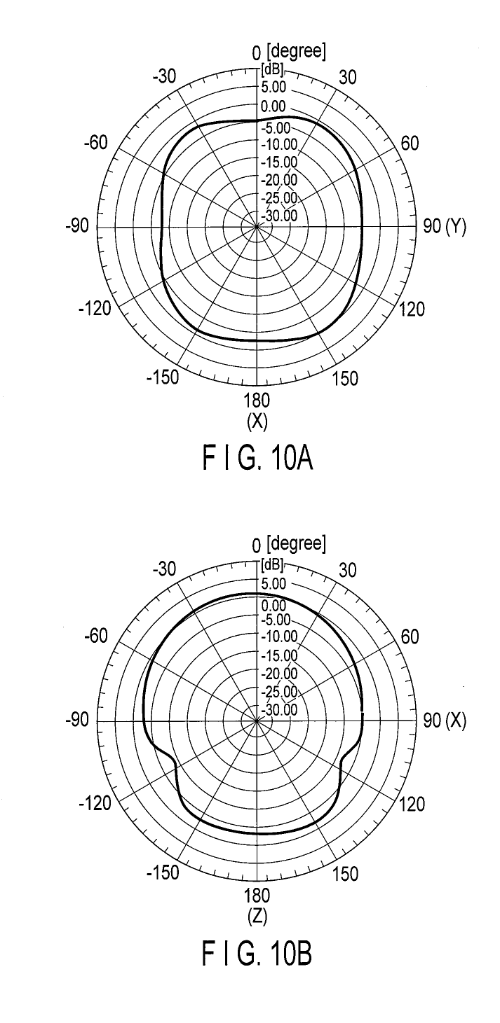

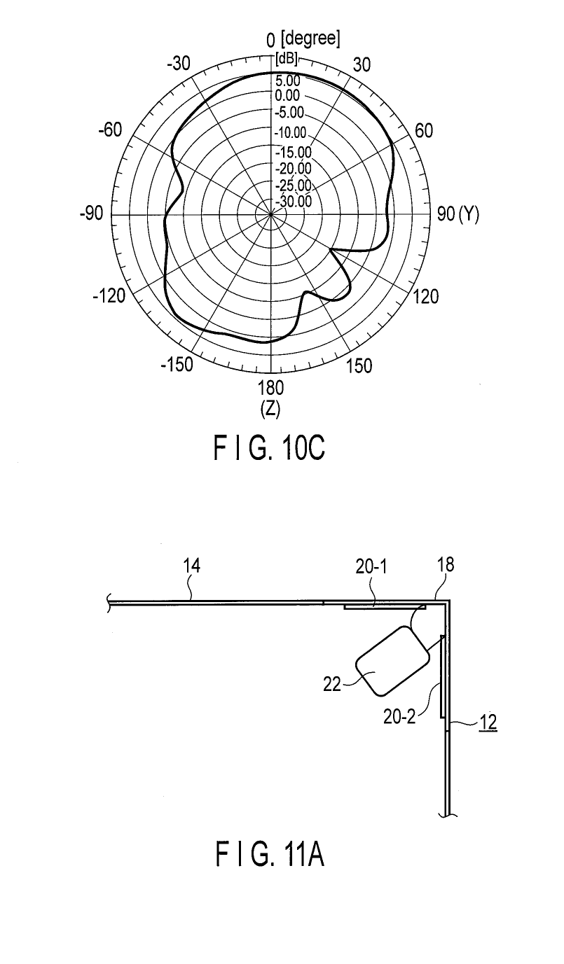

FIG. 9 shows a three-dimensional emission pattern when the display apparatus shown in FIG. 7A is longitudinally placed, and the antenna 20 is placed in the lateral direction. FIG. 10A, FIG. 10B and FIG. 100 are graphs showing emission patterns of the transmission wave from the antenna device within the X-Y plane, X-Z plane and Y-Z plane of the three-dimensional emission pattern shown in FIG. 9.

As clear from the comparison of FIG. 8A, FIG. 8B and FIG. 8C with FIG. 10A, FIG. 10B and FIG. 100, the emission patterns are different between the case where the antenna 20 is longitudinally provided and the case where the antenna 20 is laterally provided. When the antenna 20 is longitudinally provided, as shown in FIG. 7B, it is clear that there is a null point in the Y-axis direction from the drawing in which an emission pattern is superimposed on the display apparatus (structure). As shown in FIG. 8A and FIG. 8C, the pattern is formed as a pattern close to the emission pattern of the case where a dipole antenna is provided in the horizontal direction (Y-axis direction). On the other hand, when the antenna 20 is laterally provided, as shown in FIG. 9, similarly, from the drawing in which an emission pattern is superimposed on the display apparatus (structure), it is clear that there is a null point in the Z-axis direction. As shown in FIG. 10B and FIG. 100, the pattern is formed as a pattern close to the emission pattern of the case where a dipole antenna is provided in the vertical direction (Z-axis direction).

By arranging the antennas 20-1 and 20-2 longitudinally and laterally, the emission patterns shown in FIG. 7A and FIG. 9 are synthesized, and both polarized waves can be generated. Further, the gain of emission patterns can be improved by placing the antennas 20-1 and 20-2 on the resin bezel members 18-1 and 18-2.

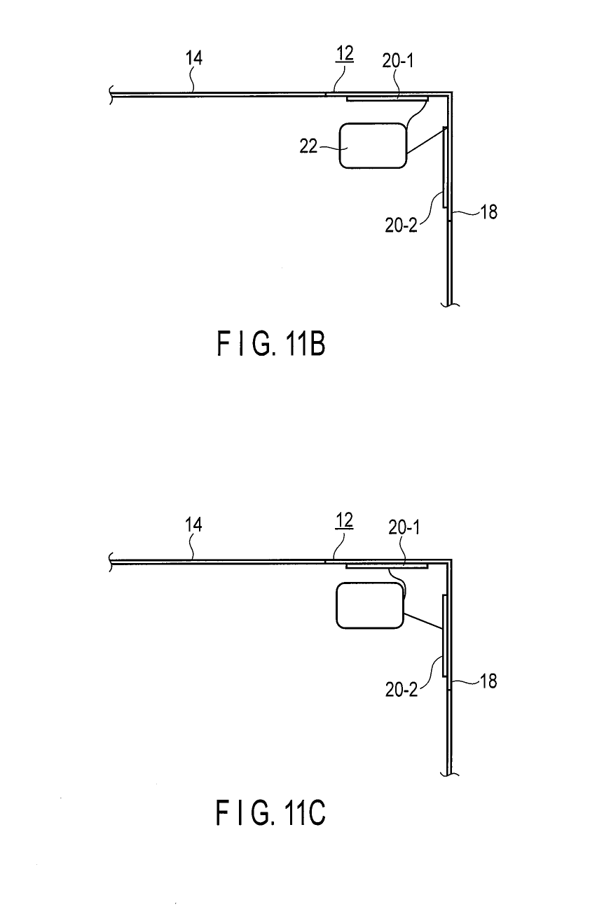

In the case where the antennas 20-1 and 20-2 are provided on the resin bezel members 18-1 and 18-2, the antenna module 22 may not be provided so as to be symmetrical on the diagonal line as shown in FIG. 11A as long as the antennas 20-1 and 20-2 are provided so as to be symmetrical on the diagonal line. As illustrated in FIG. 11B, the antenna module 22 may be provided along the long side of the display panel. The connection points of the antennas 20-1 and 20-2 to the power supplying point can realize connection through flexible cables. The connection points are not limited to ends of the antennas 20-1 and 20-2, and may be realized by various embodiments. For example, as shown in FIG. 11C, the connection points may be the middle point of each of the antennas 20-1 and 20-2. According to these embodiments, the antenna property can maintain symmetry, and the space efficiency can be improved in terms of component mounting by arranging the antenna module in parallel with the bezel member.

In the various embodiments described above, the resin bezel members are expressed as resin bezel members 18, 18-1 and 18-2. However, it is clear that the bezel members should only comprise a bezel structure formed from a nonconductive material. It is also clear that the metal bezel member 14 should be only formed from a conductive material. The main substrate provided on the back surface of the display panel 10 does not need to have the same dimension as the display portion of the display panel 10, and may be smaller than the display portion. The main ground plate (GND plate) of the main substrate is a structure which is strong to support the display portion and the whole apparatus. Use of metal is an easy way to obtain a strong structure. However, the main ground plate does not necessarily conform to the ground potential (GND potential) of the built-in electronic circuit. Although the plate is referred to as a main ground plate (GND plate), it may be composed by a nonconductive member depending on the structure of the apparatus and the desired strength.

As described above, it is possible to stabilize the performance at the time of 802.11n MIMO operation by arranging antennas in the specific positions. In other words, the performance can be stabilized by arranging the plurality of antennas 20-1 and 20-2 or 24-1 and 24-2 on or near the resin bezel members 18-1 and 18-2 in such a way that both polarized waves are equally generated.

Thus, in the case where the antenna performance can be improved in the display apparatus, and the variation of the wireless performance can be reduced, and the frame 12 is composed by a bar type of bezel member, the bar type of bezel member can be easily mounted and exchanged, and the display apparatus can be easily produced and repaired.

According to the display apparatus of the embodiments, it is possible to realize an antenna alignment state which compares favorably with a single wireless module, and realize stabilized wireless communication which does not rely on the way of placing the device. Moreover, the manufacturing and design in metal bezel members can be improved. The deterioration in the wireless performance due to the attempt to narrow metal frames can be suppressed. Further, even in the structure which could not prevent the reduction in the performance, there is an advantage of efficiently emitting electronic waves to the liquid crystal surface side.

By the arrangement of both polarized waves in which an MIMO effect can be easily obtained, it is possible to realize stabilized communication at the time of viewing a digital signage display for wall-hanging whose performance is extremely reduced in the back surface antenna arrangement, or longitudinally or laterally viewing a tablet/smartphone comprising one antenna in the current same communication system. Moreover, it is possible to realize a high SNR which is essential for a high communication rate such as 256 QAM modulation at the time of transmitting images and sounds in high quality.

The present invention is not limited to the above-described embodiments, but may be realized by modifying structural elements without departing from the scope. Various inventions can be realized by appropriately combining the structural elements disclosed in the embodiments. For instance, some of the disclosed structural elements may be deleted. Some structural elements of different embodiments may be combined appropriately.

What is claimed is:

1. A display apparatus comprising:
a display panel comprising a substantially oblong outer shape having four corners and four sides, a display surface on a front surface, and a flat placement area adjacent to at least one of the four corners on a back surface;
a frame configured to retain the display panel, the frame being composed of four metal bezel members attached to the four sides, and two nonconductive bezel members which are connected to two of the four metal bezel members, are attached to, among the four sides, two sides to which the two metal bezel members are attached in order to extend the two metal bezel members, and constitute a substantially L-shape, and the frame defining a triangular area or a rectangular area formed by the two nonconductive bezel members as linear two sides;
at least a pair of antennas provided on the resin bezel members or in the flat placement area in order to be substantially symmetrical with respect to a diagonal line connecting said one corner and an opposing corner opposed to said one corner, or a bisector bisecting said one corner; and
an antenna module comprising a portion in which at least a part of the antenna module overlaps the triangular area or the rectangular area, the antenna module being placed and fixed in the flat placement area of the display panel, being connected to the antennas, comprising a power supplying portion supplying electric power to the antennas, and driving the antennas in order to constitute a group of antennas communicating at a same time in a same system.

2. The display apparatus of claim 1, wherein the nonconductive members include resin.

3. The display apparatus of claim 1, wherein a main plate or a main ground plate is provided on the back surface of the display panel, and the antenna module and the pair of antennas are placed on an antenna plate placed on the main plate or the main ground plate.

4. The display apparatus of claim 3, wherein each of the nonconductive bezel members has a length determined in a range of ¼ wavelength to one wavelength of a frequency for using the antennas, and a distance from a connection portion between the metal bezel members and the nonconductive bezel members to a free end of the antennas is determined as 1/10 wavelength or more.

5. The display apparatus of claim 1, wherein the group of antennas resonates at a multifrequency, and is operated in any of a plurality of communication bands depending on a need.

6. The display apparatus of claim 1, wherein the apparatus being composed in order not to provide a wiring pattern for grounding or a ground plate in the triangular area.

7. The display apparatus of claim 1, wherein the display panel is composed from an organic light-emitting diode (OLED) organic EL.

8. The display apparatus of claim 1, wherein the two antennas are fixed in the nonconductive bezel members respectively, and the antennas are connected to the antenna module by flexible cables.

9. The display apparatus of claim 8, wherein the module is provided substantially in parallel with one of the nonconductive bezel members.
